(19) United States
(12) Patent Application Publication
(10) Pub. No.: US 2013/0058072 A1
(43) Pub. Date: Mar. 7, 2013

(54) LIGHT-SOURCE DEVICE

(71) Applicant: Minoru Yagi, Inagi-shi (JP)

(72) Inventor: Minoru Yagi, Inagi-shi (JP)

(73) Assignee: Intexs Corporation, Tokyo (JP)

(21) Appl. No.: 13/638,688

(22) PCT Filed: Mar. 31, 2011
(86) PCT No.: PCT/JP2011/058300

§ 371 Date: Nov. 13, 2012

(30) Foreign Application Priority Data
Mar. 31, 2010 (JP) 2010 094450
Jan. 26, 2011 (JP) 2011 013544

(51) Int. Cl. F21V 23/00; F21V 9/16

(52) U.S. Cl. 362/84; 362/231

(57) ABSTRACT

Disclosed is a light-source device that allows for the color recognition and can prevent a UV (ultraviolet)-sensitive illuminated object from becoming exposed. A user can freely select the wavelength of said light-source device in accordance with the intended use. The light-source device is provided with a light-source unit comprising a combination of a plurality of light-emitting diode elements that emit different wavelengths of light; a control unit that controls the output of each of the various light-emitting diode elements in the light-source unit independently of each other; and a power supply unit that supplies power to the light-source unit and the control unit. The plurality of light-emitting diode elements include, at least, a blue light-emitting diode element. The blue light-emitting diode element emits a blue light with a wavelength of at least above 420 nm.

### BACKGROUND

1. Technical Field

The present invention relates to a light-source device. More particularly, the present invention relates to the light-source device that allows its user to recognize colors and that can prevent any of the UV-sensitive illuminated objects from becoming exposed to the light.

2. Description of the Prior Art

As the light source that is currently used in the semiconductor manufacturing factory or the like, a yellow fluorescent lamp that is specifically designed for use in the semiconductor manufacturing factory or the like is employed.

The yellow fluorescent lamp may have a coating of filter film applied thereon or may be covered with a plastics film, and is so designed that it can remove or eliminate any harmful or unwanted wavelength range. The yellow fluorescent lamp being so designed can prevent any of the light sensitive materials from becoming exposed to the light.

Under the working conditions under which the working environment is illuminated by those fluorescent lamps, however, it is impossible that this working environment will provide the comfortable environment as far as the intensity of the lamp, the color recognition and the like are concerned. Under those working conditions, more specifically, it is hard to discern the differences between yellow and white colors or blue and black colors.

In our everyday life, however, the intensity of the lamp, the colors and the like can be recognized easily and freely. There is a desire that people will work in the environment similar to that of the everyday life, and this desire is increasing as the level of the human life becomes higher.

In the technique described above, the fluorescent lamp is covered with a yellow film that filters out any UV rays so that any yellow light emission can be eliminated. This technique provides the means for removing any of the harmful wavelengths contained in the wavelength spectrum of the light emitted by the fluorescent lamp, and the light source is therefore covered with the yellow film. In other words, this technique employs the subtraction-based method that may remove any unwanted wavelengths contained in the wavelength spectrum of the light emitted by the fluorescent lamp. The light source is so covered that any unwanted wavelength can be removed.

The prior art technology of the type described above is disclosed in the patent document 1 cited below in the prior patent document, for example.

It may be appreciated from the foregoing description that the conventional light source that is used in the semiconductor manufacturing factory and the like presents problems in that it is impossible to recognize the colors accurately, which causes some troubles in making the various data entries or performing the manual operations in which the high precision and strict working environment is required.

For the conventional fluorescent lamps or tubes, they must be replaced one time for the two or three years, which causes the troublesome maintenance problem or burden.

In the conventional technique described above that employs the subtraction-based method in which any unwanted wavelength of the light in the wavelength spectrum can be removed, a multilayer film filter may be used to remove any unwanted UV wavelength rapidly. Actually and usually, however, this filter is not used because it is expensive.

In order to remove the UV wavelength, the optical filter that absorbs the wavelength in the neighborhood of usually 530 nm is used. The result is the yellow light-source device.

The wavelength spectrum provided by the conventional light-source device contains a fewer wavelengths of the light below the green color. In this case, there is a problem in that using this light source, the user cannot discern the differences between the colors, such as the green and blue.

In the recent years, the white light emitting diode element has been noticed, and has now been used in the various fields. This diode element also produces a white light by adding a fluorescent substance to a blue color. As a result, the light-source device that allows its user to select the wavelength as desired is not available

### PRIOR PATENT DOCUMENT

Patent application document as published under No. 2002-243915

### SUMMARY OF THE INVENTION

One object of the present invention is to provide a light-source device that allows its user to recognize colors and that can prevent any of the UV-sensitive illuminated objects from becoming exposed. Another object of the present invention is to provide a light-source device that allows its user to select the wavelength freely according to the particular usage intended by the user. A still another object of the present invention is to provide a light-source device that provides the long life time, bright light and comfortable environment.

A light-source device proposed by the present invention comprises:

a light-source unit including a combination of a plurality of light-emitting diode elements each having a different wavelength;

a control unit that controls the output of each of the light-emitting diode elements in said light-source unit independently from each other; and

a power-supply unit that supplies power to each of said light-source unit and said control unit, wherein said plurality of light-emitting diode elements include, at least, a blue light-emitting diode element, and said blue light-emitting diode element emits the blue light having the wavelength characteristic of at least above 420 nm.

Another light-source device proposed by the present invention comprises:

a light-source unit including a combination of a plurality of light-emitting diode elements each having a different wavelength;

a control unit that controls the output of each of the light-emitting diode elements in said light-source unit independently from each other; and

a power-supply unit that supplies power to each of said light-source unit and said control unit, wherein said plurality of light-emitting diode elements include, at least, a red light-emitting diode element and a green light-emitting diode element.

A further light-source device proposed by the present invention comprises;

a light-source unit including a combination of a plurality of light-emitting diode elements each having a different wavelength;

a control unit that controls the output of each of the light-emitting diode elements in said light-source unit independently from each other; and

a power-supply unit that supplies power to each of said light-source unit and said control unit, wherein said plurality of light-emitting diode elements include, at least, a blue light-emitting diode element, a red light-emitting diode element and a green light-emitting diode element and wherein said blue light-emitting diode element emits blue light having the wavelength characteristic of at least above 420 nm.

As one of the advantages of the present invention, it provides the light-source device that allows its user to recognize colors and that can prevent any of the UV-sensitive illuminated objects from becoming exposed to the light. As another one of the advantages of the present invention, it provides the light-source device that allows its user to select the wavelength freely according to the usage intended by the user. As still another one of the advantages of the present invention, it provides the light-source device that provides the long life time, bright light and comfortable environment.

### BRIEF DESCRIPTION OF DRAWINGS

FIG. 1 is a block diagram that illustrates the arrangement of one example of the light-source device in accordance with the present invention;

FIG. 2 is a wavelength spectrum for the light-source device in accordance with the present invention;

FIG. 3 show the structure of the human eye, in which (a) shows the whole structure of the human eye and (b) shows the structure of the optic nerves for the human eye; and

FIG. 4 is a diagram of the general wavelength spectrum that is employed in the conventional semiconductor manufacturing factory.

### BEST MODE OF EMBODYING THE INVENTION

The light-source device provided in accordance with one embodiment of the present invention comprises:

a light-source unit including a combination of a plurality of light-emitting diode elements each having a different wavelength;

a control unit that controls the output of each of the light-emitting diode elements in said light-source unit independently from each other; and

a power-supply unit that supplies power to each of said light-source unit and said control unit, wherein said plurality of light-emitting diode elements include, at least, a blue light-emitting diode element and wherein said blue light-emitting diode element emits the blue light having the wavelength characteristic of at least above 420 nm.

The wavelengths may be added up by providing the light-source unit that includes a combination of a plurality of light-emitting diode elements each having a different wavelength. The output of each of the light-emitting diode elements may be controlled independently from each other so that the light-source device can allow its user to select the wavelength as desired by the user.

The light-source device provided in accordance with another embodiment of the present invention comprises:

a light-source unit including a combination of a plurality of light-emitting diode elements each having a different wavelength;

a control unit that controls the output of each of the light-emitting diode elements in said light-source unit independently from each other; and

a power-supply unit that supplies power to each of said light-source unit and said control unit, wherein said plurality of light-emitting diode elements include, at least, a red light-emitting diode element and a green light-emitting diode element.

The light-source device provided in accordance with still another embodiment of the present invention including the first and second mentioned light-source devices as combined together comprises:

a light-source unit including a combination of a plurality of light-emitting diode elements each having a different wavelength;

a control unit that controls the output of each of the light-emitting diode elements in said light-source unit independently from each other; and

a power-supply unit that supplies power to each of said light-source unit and said control unit, wherein said plurality of light-emitting diode elements include, at least, a blue light-emitting diode element, a red light-emitting diode element and a green light-emitting diode element and wherein said blue light-emitting diode element emits blue light having the wavelength characteristic of at least above 420 nm.

Each of the light-source devices of the present invention described above may provide a light source that prevents the UV-sensitive illuminated object from becoming exposed, and may include a plurality of light-emitting diode elements each having a different wavelength.

In each of the light-source devices of the present invention described above, a plurality of light-emitting diode elements each having a different wavelength may be mounted on the same circuit board in order to allow any desired wavelength to be selected from the wavelengths contained in the wavelength spectrum.

In each of the light-source devices of the present invention described above, the plurality of light-emitting diode elements may include, at least, a blue light-emitting diode element having the blue light wavelength of above 420 nm and below 490 nm, wherein the power consumption required for said blue light-emitting diode element is controlled so that it can be within 0.1% and 30% of the total power consumption required for the light-source unit.

In each of the light-source devices of the present invention described above, the plurality of light-emitting diode elements include, at least, a blue light-emitting diode element having the blue light wavelength of above 420 nm and below 490 nm, wherein the light emission provided by said blue light-emitting diode element is controlled so that it can be between above 0.001 mJ/cm² and below 50 mJ/cm².

In each of the light-source devices of the present invention described above in which the plurality of light-source emitting diode elements provided in the light-source unit and each having a different wavelength include the blue light-emitting diode element, it may be understood that the objects of the present invention as described earlier can be attained by controlling the blue light-emitting diode element so that it can provide the blue light wavelength characteristic of at least above 420 nm. Specifically, the color recognition will be enabled, and the maintenance costs can be reduced considerably.

By limiting the wavelength of the blue light-emitting diode element as described above, furthermore, the objects of the present invention can be attained more effectively. Specifically, the color recognition will thus be enabled, and the maintenance costs can be reduced more considerably.

In order to enable the color recognition and in order to prevent the UV-sensitive materials from becoming exposed as much as possible, the objects of the present invention can be attained by including the blue light-emitting diode element in the light-source unit and by limiting its wavelength accordingly.

In each of the light-source devices of the present invention described above, the light-source unit may have a coating of any suitable filter film applied thereon or may be covered by any suitable plastics film in order that any UV rays of below 420 nm can be removed. In this way, the UV rays can be removed more safely and more effectively.

In each of the light-source devices of the present invention described above, furthermore, each of the plurality of the light-emitting diode elements may have a coating of any suitable fluorescent substance applied thereon. In this way, the spectrum forms and the like may be modified.

In each of the light-source devices of the present invention described above, the light-source unit may be any one of the electric bulb type, line type and surface light-emitting type light-source units.

When the light-source device of the present invention is used as the light-source device specifically designed for use in the semiconductor manufacturing factory, it may include three types of light-emitting diode elements each having a different wavelength, such as red (630 nm), green (525 nm) and blue (450 nm), for example. The light-source device may comprise the light-source unit that includes one combination of those three light-emitting elements, the control unit that controls the intensity of each of the red, green and blue light-emitting diode elements independently of each other, and the power supply unit that supplies power to the light-source unit and control unit. The control unit is provided for controlling each of the red, green and blue light-emitting diode elements included in the light-emitting unit. In this way, the light emitted from the light-emitting unit can be set to any appropriate spectrum, and the intensity of the light emitted from each of those light-emitting diode elements having the different wavelength can be adjusted accordingly.

The light-source unit that includes the plurality of light-emitting diode elements each having a different wavelength, such as the red light-emitting diode element, the green light-emitting diode element and the blue light-emitting diode element, is provided for controlling those light-emitting diode elements independently of each other. Furthermore, the light-source unit may control the output of the blue light-emitting diode in particular so that this diode can be optimized. This provides the wavelength spectrum that is hard to be exposed to any light-sensitive material. For example, the light source that prevents any UV-sensitive illuminated object from becoming exposed and that permits the colors to be recognized accurately and easily can be provided. This light source can meet those two mutually contradicting purposes so that they can be compatible with each other.

Under the illumination that may be provided by each of the light-source devices of the present invention described above, all colors can recognized. Thus, the machines, the equipment, the furniture and the like in the factory can be identified by the color. Advantageously, the working efficiency, the yields and the like can be improved considerably. Furthermore, the maintenance costs can be reduced remarkably by decreasing the replacement work, such as one time for the two or three years.

Each of the light-source devices of the present invention described above allows the user to recognize that the ordinary illumination is provided by the light source and that the light source is hard to be exposed to any light sensitive material. As such, the extremely excellent effects can be provided. In addition, the working environment for the user can be improved considerably and the working efficiency can also be improved.

Now, the particular embodiment of the present invention and the examples thereof will be described by referring to the accompanying drawings.

### EMBODIMENT

FIG. 1 is a block diagram that illustrates one example of the light-source device having the structure described above in accordance with the present invention.

In FIG. 1, LS refers to the light-source unit. The light-source unit LS includes a red light-emitting diode element LEDR and an electric current limiting resistance RR for limiting the output of the red light-emitting diode element LEDR, a green light-emitting diode element LEDG and an electric current limiting resistance RG for limiting the output of the green light-emitting diode element LEDG, and a blue light-emitting diode element LEDB and an electric current limiting resistance RB for limiting the output of the blue light-emitting diode element LEDB.

The light-source unit LS includes a combination of the red light-emitting diode element LEDR, the green light-emitting diode element LEDG and the blue light-emitting diode element LEDB, all of which are mounted on the circuit board (not shown) on which they are arranged in parallel with and adjacently to each other.

As the means for controlling the output, the constant electric current element may be used to control the red light-emitting diode element LEDR, green light-emitting diode element LEDG and blue light-emitting diode element LEDB that are included in the light source unit independently of each other. In addition, the pulse driving system may be used to control each of those elements with the duty ratio of the PWM signal.

Those red light-emitting diode element LEDR, green light-emitting diode element LEDG and blue light-emitting diode element LEDB may be arranged around the same circumferential periphery. For each of those red light-emitting diode element LEDR, green light-emitting diode element LEDG and blue light-emitting diode element LEDG, more than one element may be provided and arranged in parallel so that they can provide the enhanced light intensity.

In FIG. 1, PS refers to the power supply unit that supplies an appropriate power to the light-source unit LS by converting AC voltage to DC voltage.

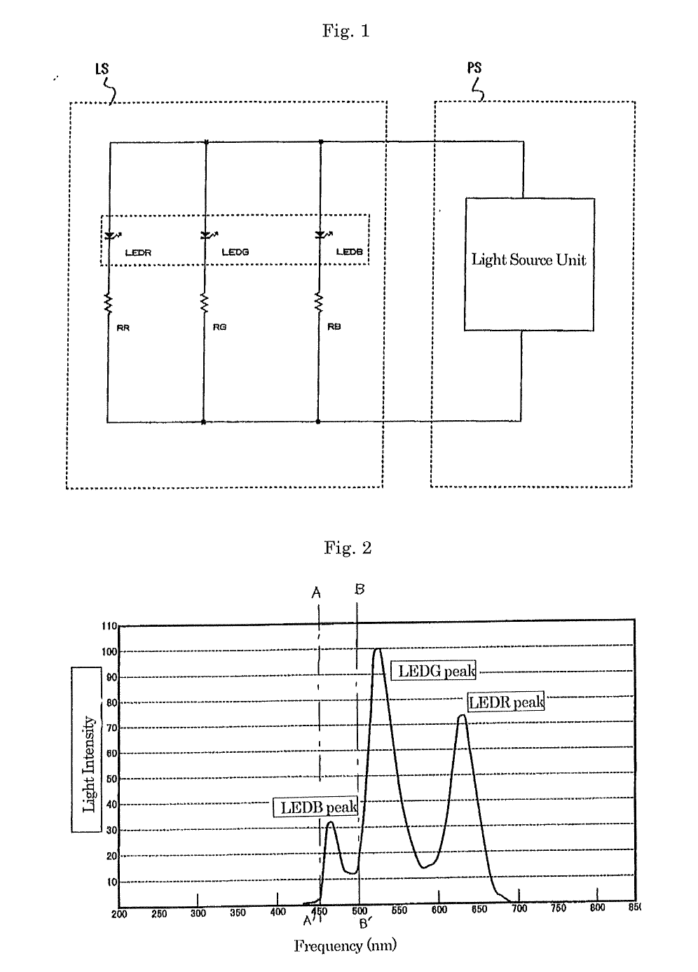

FIG. 2 shows the wavelength spectrum of the light emitted from the light-source unit LS. It has been observed that the peak wavelength for the red light-emitting diode element LEDR is equal to 630 nm, the peak wavelength for the green light-emitting diode element LEDG is equal to 530 nm and the peak wavelength for the blue light-emitting diode element LEDB is equal to 460 nm. In this way, the emission light from which the desired wavelength light source can be selected is obtained.

FIG. 2 is a wavelength spectrum diagram for the light-source device according to the present invention. As its structure is seen from this diagram, the blue light source provides sufficiently small light emission as compared with the other color light sources.

In FIG. 2, A-A′ and B-B′ refer to the blue light bandwidth. The light emission level of the blue light-emitting diode element LEDB within this bandwidth will have the very great effect on the light-sensitive material that may become exposed to the light having the wavelength of the UV band. As far as the wavelength is concerned, the blue light-emitting diode element LEDB may be characterized by the fact that this element has the light-emitting frequency above 420 nm among the other blue light wavelengths.

The UV ray wavelength that may cause the UV-sensitive material to be exposed to the light will begin to be exposed at or below 420 nm, and will present its peak around the UV ray wavelength of 360 nm. Furthermore, the light-sensitive material will be exposed by the sum of the stored energy of the wavelength, light intensity and light exposure time.

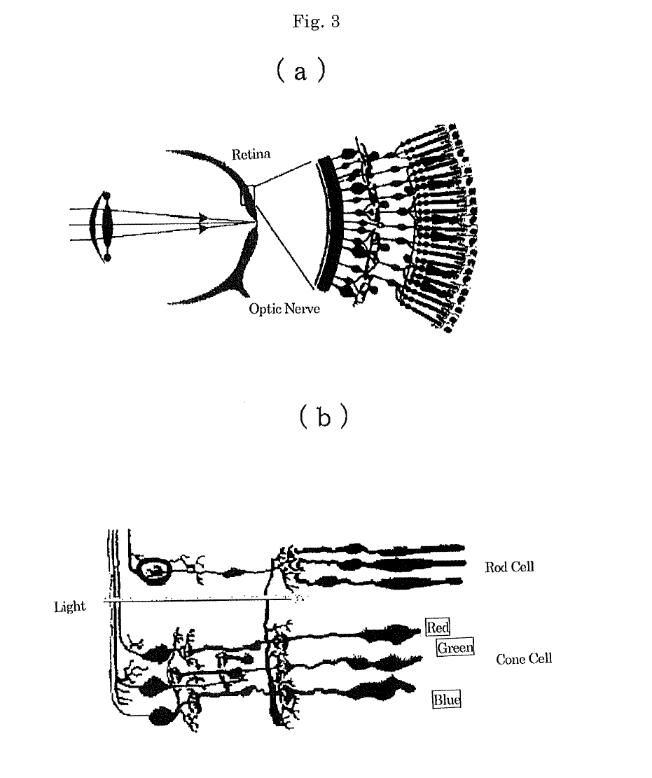

FIG. 3 shows the structure of the human eye, in which FIG. 3(a) presents the state in which light is entered from the outside and an image is then formed on the retina and FIG. 3(b) presents the structure of transmitting the light of the formed image into the optic nerves. In general, the nerves of the human eye include the optic nerve cell called the rod that senses the brightness of the light and the optic nerve cell called the cone that identifies the colors such as red, green and blue. For this reason, the colors will be able to be identified if the light sources of at least the red, green and blue can be recognized although they may provide a slight light.

It may be appreciated from the above description that the desired light emission level can be obtained by controlling the optimal output in the A-A′ and B-B′ blue light wavelength bandwidth. Based on the light emission, therefore, the light-source unit LS that allows the human eye to recognize the colors and prevents the light-sensitive material from becoming exposed to the light.

At this moment, the blue light-emitting diode element may be controlled so that it can have the blue light wavelength characteristic of at least above 420 nm. Otherwise, the blue light-emitting diode element may be controlled so that it can provide the blue light wavelength of above 420 nm and below 490 nm.

Specifically, the blue light-emitting diode element may be controlled so that it can provide the blue light wavelength of above 420 nm and below 490 nm and that the power consumption required for the light emission of the blue light-emitting diode element can be within 0.1%-30% of the total power consumption required for the light source unit.

More specifically, the blue light-emitting diode element may be controlled so that it can provide the blue light wavelength of above 420 nm and below 490 nm and that the light emission level of the blue light-emitting diode element can be above 0.001 mJ/cm² and below 50 mJ/cm².

The differences in the power consumption and light emission level as described may be determined by considering the differences in the sensitivity of the light sensitive materials.

The human eye may recognize the colors by increasing the output of the blue light-emitting diode element LEDB by a slight amount.

Any of the UV rays may be removed more safely and more effectively by covering the light source LS with any suitable UV cutoff film.

It should be understood, however, that the light emitting diode elements provided in the light source unit LS may include the orange light-emitting diode element, the yellow light-emitting diode and the green blue light-emitting diode element other than the red light-emitting diode element, the green light-emitting diode element and the blue light-emitting diode element that have been described above. Those additional light-emitting diode elements may also provide the same effects.

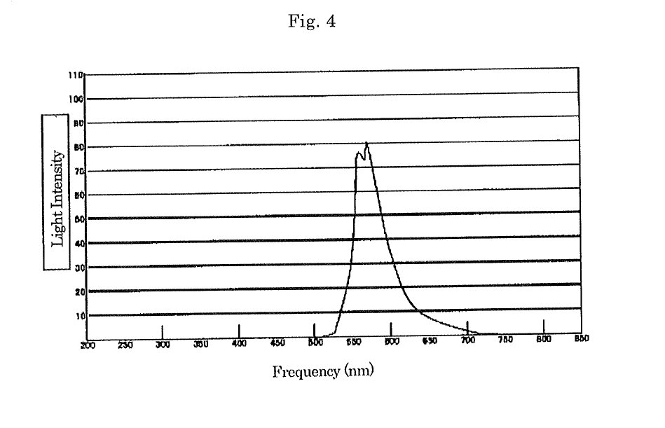

FIG. 4 shows the wavelength spectrum for the conventional light source that is employed in the semiconductor manufacturing factory. As it is seen from the wavelength in FIG. 4, this spectrum does not include any of the wavelengths that is located below 500 nm. As a result, no blue light wavelength is available under this illuminated environment. This causes the human eye to be unable to recognize the colors. It is thus impossible for the human eye to discern the difference between the blue color and the other colors. Thus, the blue color would appear to be black to the human eye. There is also no white color, which would cause the human eye to be unable to discern the difference between the white color and the blue color.

In the embodiment described so far, the light source that is specifically designed for use in the semiconductor manufacturing factory has been discussed. By allowing any appropriate wavelength to be selected as described above and by structuring the light source so as to employ the addition-based spectrum, it is of course that the light source can be implemented so that it can provide the variously usable light emissions by permitting the color tone and brightness to be controlled easily and freely. This could not be achieved by the conventional light source that employs the erasion (subtraction)-based spectrum.

In accordance with the light-source device of the present invention, any UV rays can be removed and the colors can be recognized. Accordingly, the light-source device provided by the present invention can be used in the semiconductor manufacturing factory, and may also be applied to the illumination system in the libraries, museums and the like by which the articles are illuminated and might be affected by the UV rays. As an alternative to those light sources described so far, the light-source device may also be applied to the yellow sodium lamp that may be used to repel any insects.

1. A light-source device that comprises:
a light-source unit including a combination of a plurality of light-emitting diode elements each having a different wavelength;
a control unit that controls the output of each of the light-emitting diode elements in said light-source unit independently from each other; and
a power-supply unit that supplies power to each of said light-source unit and said control unit, wherein said plurality of light-emitting diode elements include, at least, a blue light-emitting diode element and wherein said blue light-emitting diode element emits a blue light having the wavelength characteristic of at least above 420 nm.

2. A light-source device that comprises:
a light-source unit including a combination of a plurality of light-emitting diode elements each having a different wavelength;
a control unit that controls the output of each of the light-emitting diode elements in said light-source unit independently from each other; and
a power-supply unit that supplies power to each of said light-source unit and said control unit, wherein said plurality of light-emitting diode elements include, at least, a red light-emitting diode element and a green light-emitting diode element.

3. A light-source device that comprises:
a light-source unit including a combination of a plurality of light-emitting diode elements each having a different wavelength;
a control unit that controls the output of each of the light-emitting diode elements in said light-source unit independently from each other; and
a power-supply unit that supplies power to each of said light-source unit and said control unit, wherein said plurality of light-emitting diode elements include, at least, a blue light-emitting diode element, a red light-emitting diode element, and a green light-emitting diode element and wherein said blue light-emitting diode element emits blue light having the wavelength characteristic of at least above 420 nm.

4. The light-source device as defined in claim 1, wherein a plurality of light-emitting diode elements each have a different wavelength are included in the same circuit board.

5. The light-source device as defined in claim 1, wherein said blue light-emitting diode element provides blue light having a wavelength of above 420 nm and below 490 nm, and wherein the power consumption of said blue light-emitting diode element is controlled so that it can be within 0.1% to 30% of the total power consumption of said light-source unit.

6. The light-source device as defined in claim 1, wherein said blue light-emitting diode element provides blue light having a wavelength of above 420 nm and below 490 nm, and wherein the light emission of said blue light-emitting diode element is controlled so that it can be above 0.001 mJ/cm² and below 50 mJ/cm².

7. The light-source device as defined in claim 1, wherein said light-source unit is covered with a film or plastics material that is capable of removing any UV rays located below 420 nm.

8. The light-source device as defined in claim 1, wherein each of said plurality of light-emitting diode elements each having a different wavelength has a fluorescent substance applied thereon.

9. The light-source device as defined in claim 1, wherein said light-source unit is any one of the electric bulb type, line type and surface light emitting type light source units.

10. The light-source device as defined in claim 2, wherein a plurality of light-emitting diode elements each have a different wavelength are included in the same circuit board.

11. The light-source device as defined in claim 3, wherein a plurality of light-emitting diode elements each have a different wavelength are included in the same circuit board.

12. The light-source device as defined in claim 3, wherein said blue light-emitting diode element provides blue light having a wavelength of above 420 nm and below 490 nm, and wherein the power consumption of said blue light-emitting diode element is controlled so that it can be within 0.1% to 30% of the total power consumption of said light-source unit.

13. The light-source device as defined in claim 4, wherein said blue light-emitting diode element provides blue light having a wavelength of above 420 nm and below 490 nm, and wherein the power consumption of said blue light-emitting diode element is controlled so that it can be within 0.1% to 30% of the total power consumption of said light-source unit.

14. The light-source device as defined in claim 3, wherein said blue light-emitting diode element provides blue light having a wavelength of above 420 nm and below 490 nm, and wherein the light emission of said blue light-emitting diode element is controlled so that it can be above 0.001 mJ/cm² and below 50 mJ/cm².

15. The light-source device as defined in claim 4, wherein said blue light-emitting diode element provides blue light having a wavelength of above 420 nm and below 490 nm, and wherein the light emission of said blue light-emitting diode element is controlled so that it can be above 0.001 mJ/cm² and below 50 mJ/cm².

16. The light-source device as defined in claim 2, wherein said light-source unit is covered with a film or plastics material that is capable of removing any UV rays located below 420 nm.

17. The light-source device as defined in claim 3, wherein said light-source unit is covered with a film or plastics material that is capable of removing any UV rays located below 420 nm.

18. The light-source device as defined in claim 4, wherein said light-source unit is covered with a film or plastics material that is capable of removing any UV rays located below 420 nm.

19. The light-source device as defined in claim 5, wherein said light-source unit is covered with a film or plastics material that is capable of removing any UV rays located below 420 nm.

20. The light-source device as defined in claim 6, wherein said light-source unit is covered with a film or plastics material that is capable of removing any UV rays located below 420 nm.
